(19) United States
(12) Patent Application Publication
(10) Pub. No.: US 2012/0316843 A1
(43) Pub. Date: Dec. 13, 2012

(54) SYSTEMS AND METHODS FOR COMMUNICATING SPORTS-RELATED INFORMATION

(75) Inventors: Tim A. Beno, San Diego, CA (US); Andrew Curtis, Solana Beach, CA (US); Michael T. McDonnell, Carlsbad, CA (US); Thomas C. Morris, Carlsbad, CA (US); James O'Shea, III, Carlsbad, CA (US); Ryan L. Roach, Carlsbad, CA (US); Peter L. Soracco, Carlsbad, CA (US)

(73) Assignee: Cobra Golf Incorporated, Carlsbad, CA (US)

(21) Appl. No.: 13/156,116

(22) Filed: Jun. 8, 2011

(51) Int. Cl. G06F 17/10; G06F 15/16

(52) U.S. Cl. 703/2; 709/204

(57) ABSTRACT

Systems and methods of broadcasting real time information regarding a game of golf to multiple users across a network. An embodiment involves receiving requests from one or more users interested in a golf player currently playing a game of golf, receiving sensor data from one or more sensors related to a golf player, applying predictive models to the received sensor data, and transmitting the predicted data to external users. Embodiments of the systems and methods may be used to provide alerts to users or to provide statistics or other useful information to users, including the golf player.

### BACKGROUND

This disclosure relates to computer systems and methods, and in particular, to the application of computer systems and methods to sports and sports events such as golf.

Golf is a popular sport and many people enjoy watching the performance of a golf game. However, current technologies limit the ability of people to observe a game of golf. For example, a person may watch a game of golf on television. However, that person is limited in his or her ability to see the performance of any individual player because of the positioning of the cameras recording the golf game. A person cannot observe minute details about a player and thereby, for example, improve one's own game by observing that player. One cannot obtain detailed analytical statistics and one cannot choose to view the player at different positions defined by the user. The information that is provided by current technologies for observing a game of golf thus limits viewers in their ability to observe and analyze the game.

Similar issues are present in other sports and sports events. For example, many sports are broadcast live on television, such as baseball, football, soccer, and track and field. However, such broadcasts are similarly limited in the amount of information that can be conveyed to observers.

### SUMMARY

Discussed herein are various systems and methods that permit users to obtain detailed information, statistics, and predictive analytics about various sports. The embodiments described particularly reference a game of golf and aspects pertaining thereto, but it is appreciated that the systems and methods described herein may be applied to any type of sports or sporting events, or to other fields, using techniques analogous to those described.

One embodiment is a method of broadcasting real-time information regarding a game of golf to multiple users across a network. According to this method, one or more users interested in a player send requests to a computer system. The computer system receives sensor data from one or more sensors associated with the player, with the sensor data indicating, possibly among other things, real-time position and/or motion data associated with the player. Optionally, external data is also retrieved. A model, such as a predictive or mathematical model, is applied to the received sensor data and the external data, if any.

In one embodiment, the model produces real-time performance data, which may be configured for presentation on one or more user devices. The configured data may then be transmitted to one or more users.

In another embodiment, a computer system includes instructions on a computer readable storage device. Execution of the instructions causes the computer system to receive sensor data from sensors associated with a player, and apply a predictive or other model to that sensor data. In an embodiment, execution of the instructions further causes the generation of graphical display data based on the real-time summary data from the model and transmission of the graphical display data to users interested in the player.

Another embodiment is a method of generating a real-time prediction of a golf ball trajectory or trajectory of another type of item. First, sensor data is received, indicative of a motion such as a golf swing. Weather data and/or terrain data associated with a location of the action may optionally be obtained. This data is then used to calculate an estimated trajectory, optionally in real time. In an embodiment, the trajectory may be compared to a user-provided condition, and an alert may be transmitted if that condition is satisfied.

### BRIEF DESCRIPTION OF THE DRAWINGS

FIG. 1 is a diagram illustrating one embodiment of a system of broadcasting information about golf.

FIG. 2 illustrates possible placement of sensors on and around a golf player as used in various embodiments.

FIG. 3 is a flowchart of one embodiment of a method of broadcasting information about golf.

FIGS. 4A and 4B are flowcharts of embodiments of methods of predicting and transmitting golf-related information.

FIG. 5 is a flowchart of an embodiment of a method of generating 3-dimensional modeling data.

FIG. 6 illustrates a sample user interface that provides information about a golf stroke.

FIG. 7 illustrates a sample user interface that provides statistics about a player.

FIG. 8 illustrates a sample user interface that provides comparison information about several players.

FIG. 9 illustrates a sample user interface that provides a comparison of a player's performance on a map.

FIG. 10 illustrates a sample user interface that provides information about multiple users on a golf course.

FIG. 11 illustrates a sample user interface that provides information about nearby players.

FIG. 12 illustrates a sample user interface that provides information about a golf stroke in real time.

FIG. 13 is a flowchart of an embodiment of a method of presenting a display of a trajectory of a golf ball.

FIGS. 14A and 14B are block diagrams illustrating embodiments of systems that transmit golf-related information.

These and other features will now be described with reference to the drawings summarized above. The drawings and the associated descriptions are provided to illustrate certain embodiments of the invention and not to limit the scope of the invention. Throughout the drawings, reference numbers may be re-used to indicate correspondence between referenced elements. In addition, the first digit of each reference number generally indicates the Figure in which the element first appears.

### DETAILED DESCRIPTION

Systems, methods, processes, and data structures which represent one embodiment of an example application of the invention will now be described with reference to the drawings. Variations to the systems, methods, processes, and data structures which represent other embodiments will also be described.

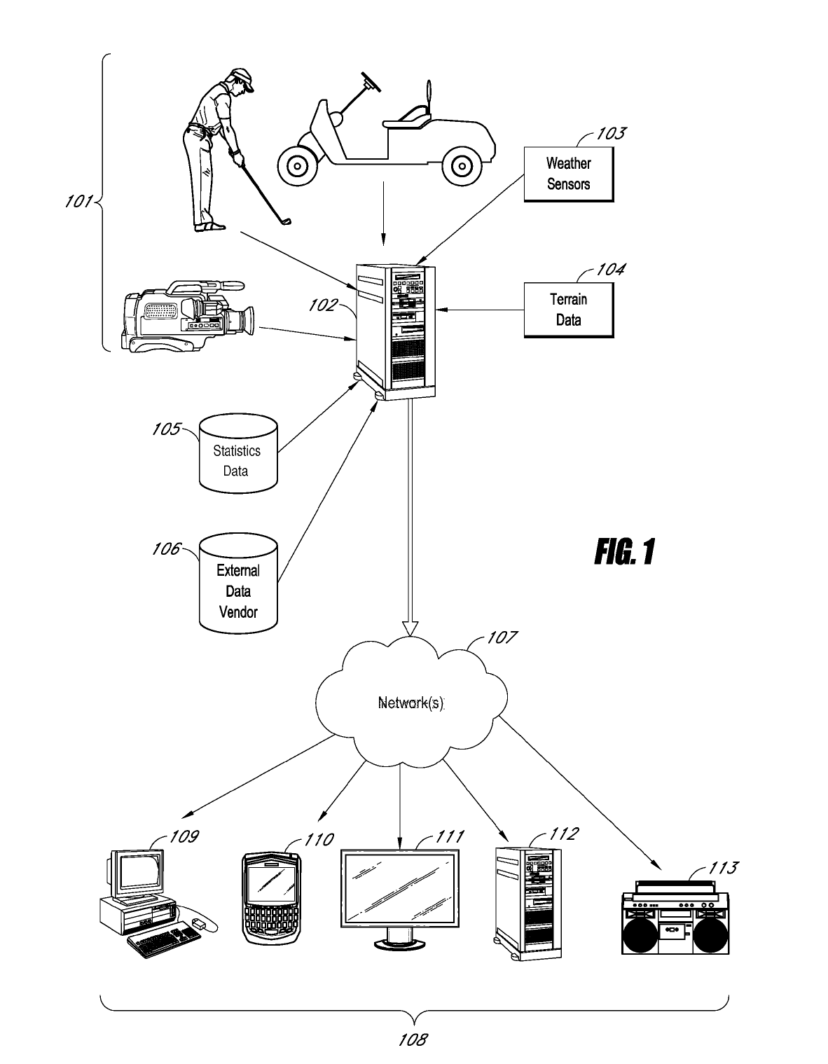

FIG. 1 depicts a block diagram of one embodiment of a data collection server 102 in communication with various devices in order to collect data and/or provide data to respective devices. The system includes any number of sensors 101 which provide information associated with the golf players playing a game of golf (or possible practicing golfing techniques). These sensors may be attached to any number of items related to the golf game. In an embodiment, they may be attached to a golf club, or to the body of a golf player. Additionally or alternatively, they may be attached to a golf cart, to a golf bag, to other people observing the golf game, or other objects. Sensors may also include, for example, cameras or other long-range sensors placed on the ground, in trees, or in other places, that detect information about the game of golf being played. Sensors may also be placed in the golf ball in some embodiments. The types of sensors may include such general items as weather sensors, humidity sensors, or terrain sensors.

The sensors may be able to record such information as current position, motion, amount of pressure, speed, acceleration, temperature, location of external items and the like. They may be set to detect information about the ball, the club, the player, or other relevant objects. The sensors may be able to communicate with each other to determine relative distances or relative speeds. Sensors may include GPS features to determine the precise location of items and they may include such items as gyroscopes, accelerometers, and other detection mechanisms.

One or more of the sensors may be connected via a network to the data collection server 102. The data collection server 102 is able to receive information from the sensors by wired or wireless networks, cell phone communications, infrared communications, Bluetooth communications, near field communication, passive or active Radio Frequency (RF) communication, or other communicative means known to those of skill in the art. In an embodiment, the sensors are connected to the data collection server through other sensors, thus forming a mesh or grid network of sensors.

In one embodiment, some or all of the sensors are RFID tags or devices. These may be used, for example, to identify individual players, particular equipment, particular events, or the like. RFID tags may be used in conjunction with other types of sensors, such as motion sensors, for example to identify a particular player currently swinging a golf club or taking other action. As another example, RFID tags may be used to quickly determine which golf club a player has selected, possibly even more quickly or accurately than a person observing the player.

The data collection server 102 may comprise a single server or multiple computer devices connected via a network or by other means. In one embodiment, the data collection server 102 comprises a first device that receives information from the sensors and a second device that processes data received by the sensors. In other embodiments, the data collection server 102 is a single device. In still other embodiments, the data collection server 102 may be implemented on a distributed computing system or cloud computing system. Thus, the operations performed by the data collection server 102 and other computing devices described herein may be performed using an individual device or using a system of multiple devices.

The data collection server 102 may receive information from sources other than the sensors. For example, in addition to, or instead of, receiving information from weather sensors 103 regarding current weather conditions, the data collection server 102 may be configured to communicate with one or more weather information data sources. The data collection server 102 may also receive terrain data 104 relating to the layout of a golf course on which the game of golf is being played. The terrain data may come from real time observation of the golf course or may come from prerecorded information about the golf course. This terrain data may include such things as the layout of the course, the geometry of individual holes, the current pin locations, the position of hazards, the height and slope of various parts of the course, the type and property of the grass, and other information that may be used in the system.

The data collection server 102 may also receive data from any number of data structures or data storage devices. The data structures may be internal to the data collection server 102 or they may be external and connected via a network or other means. For example, the data collection server 102 may receive data from a statistics data structure 105. The statistics database may contain data such as player data or historical data about the course, information about the golf clubs that the player is using, and/or information about recent games of golf that have been played either by the golf player or in the same location or other similar locations. The data collection server 102 may also receive data from external data vendors 106. These data vendors may provide statistics about players, collected data, demographic data, equipment data, or other data that may be used by the data collection server 102.

In the embodiment of FIG. 1, the data collection server 102 is connected to a network 107, which comprises any communication network or combination of communication networks, such as one or more of the Internet, LANs, WANs, MANs, etc., for example. In further embodiments, the data collection server 102 may be connected to other networks, such as ad hoc networks, cell phone networks, or the like. Other forms of communication, such as audio or television broadcasts may also be used, and any combination of these networks or other communication systems may be used as well. The data collection server 102 may send sensor data directly to the Internet or other systems, or it may perform processing on the data beforehand. This processing may include mathematical modeling, statistical calculations, predictive calculations, generation of user interfaces, or the like, in which case the resulting data may be sent to the network 107 possibly along with the sensor data. The processing may be performed based on one or more computer programs stored in the data collection server 102. In an embodiment, these programs are web application programs that receive input from users over the network 107.

In an embodiment, the data sent from the data collection server 102 to the network 107 is formatted for one or more user devices 108. Such user devices may include computers 109, mobile phones or mobile computing devices 110, televisions 111, servers 112, radios 113, and other such communication devices. In an embodiment, the data collection server 102 is aware of the type of user devices to which the data collection server is sending information and it formats that data appropriately for the user device. For example, the data sent to a mobile device 110 may be especially adapted for a mobile device screen, whereas the same data sent to a computer 109 may be adapted for a computer screen. Data may be further customized based on characteristics of particular devices and/or user preferences, such that mobile devices having different display sizes, processor speeds, and/or user preferences, may receive different quantities, types, and/or formats of data. This provides users with an improved viewing experience when following the game of golf. In one embodiment, the data may be formatted for and transmitted to only one type of device, such as a PDA. In other embodiments, particular types of devices and/or data formats are supported. In an embodiment, the user is enabled, via a user interface, to choose a particular data format, so that the user may enjoy a more customized experience.

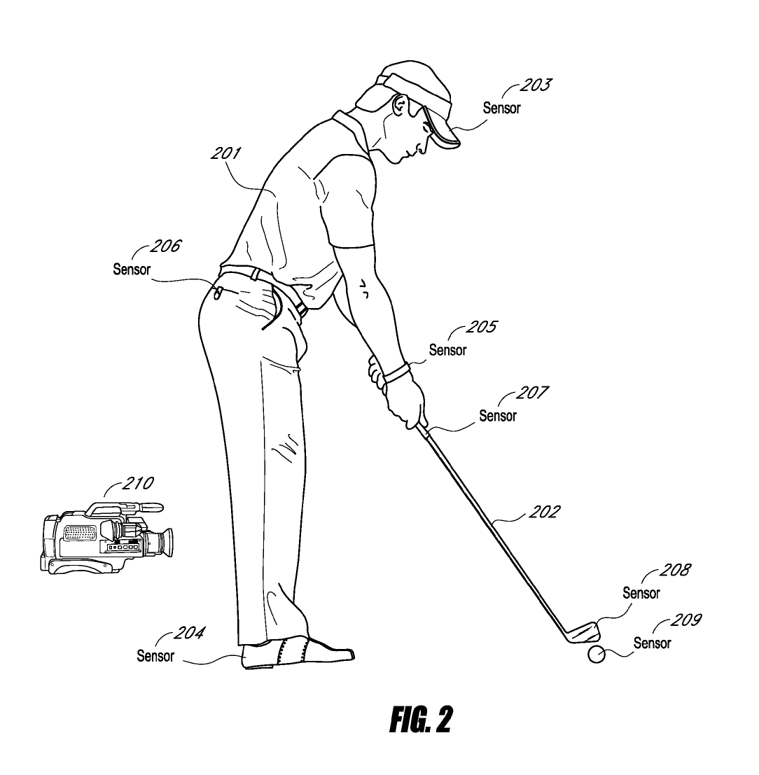

FIG. 2 depicts an embodiment of a golf player 201 outfitted with a number of sensors. These sensors may be placed in any number of locations on the body of the golf player 201 or the golf club 202. For example, the golf player 201 may have a sensor embodied in his hat 203 which may be configured to observe the positioning of the player's head or the motion of the player's head. The sensor 203 may be outfitted, as well, with a camera or other such device to observe the player's swing or the striking of the golf ball. Sensors may be placed in the golf player's shoes 204 to allow for measurement, for example, of the player's foot positioning, stance, weight distribution, and other such information that may be useful in analyzing the golf player's performance. A sensor may also be placed on the wrist 205 of the golf player 201 which may track the player's swing velocity, position, and/or other information relating to the player's performance. Other sensors may be placed on the golf player, such as sensor 206 in the player's back pocket which may provide additional information about the player's stance, position, or motion. Any combination or subset of these sensors may be used, or other sensors may be used, in various embodiments. Additionally, references to sensors in FIG. 2 and throughout this description should be interpreted to include one or more sensors. Thus, each of the sensors indicated in FIG. 2 may actually include multiple sensors, such as an accelerometer, GPS, and imaging sensor.

Sensors on the club 202 may include one or more sensors on the shaft 207 of the club 202 which similarly can measure such information as speed, velocity, acceleration, and/or position of the golf club, thus providing information about the golf player's swing and the striking of the ball. Sensors may also be placed in the face 208 of the club 202. Such sensors may be useful, for example, in measuring the timing of when the club 202 strikes the ball, the location on the face 208 where the club 202 strikes the ball, the angle of the club at various times during the swing, the speed and acceleration of the club, any torque or torsion force on the club, and/or the speed and acceleration of the ball upon striking.

Sensors may further be placed in the ball 209 itself which may allow for measurement of the speed, acceleration, rotation or velocity of the ball as it leaves a standing position, or providing information about the altitude and distance of the ball's flight, for example.

In some embodiments, sensors need not be directly positioned on the player or the club. For example, camera sensor 210 may be used to record video or audio information or other information about the golf player's swing or about the position and trajectory of the golf ball.

Several flowcharts and related methods are described hereinafter. Although each flowchart illustrates a particular quantity of blocks, the methods associated with the flowcharts may include any subset of illustrated blocks, or may include additional blocks that are not illustrated. Also, the blocks may be performed in orders different than illustrated in the figures. Software code configured for execution on a computing system in order to perform the methods of respective flowcharts may be provided on a computer readable medium, such as a compact disc, digital video disc, flash drive, hard drive, memory device or any other tangible medium. Such software code may be stored, partially or fully, on a memory of a computing system, such as the computing devices 102, 1400A, 1400B, and/or other suitable computing systems, in order to perform the illustrated methods by those respective devices. For ease of explanation, the methods will be described herein as performed by a computing system, which should be interpreted to include any one or more of the computing systems noted above, any combination of those computing systems, and/or any other suitable computing system.

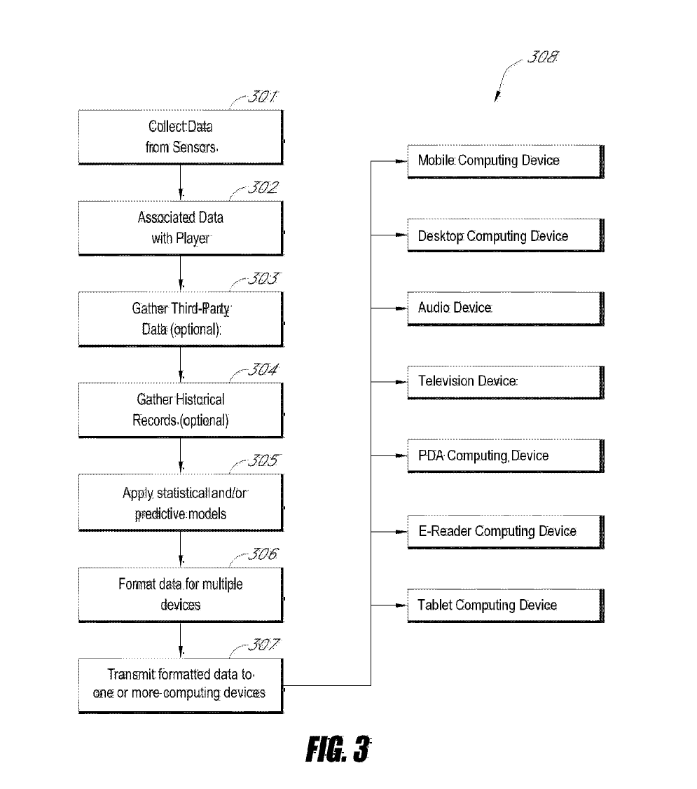

FIG. 3 is a flowchart depicting one embodiment of a method of broadcasting information about a golf game. Beginning at block 301, the computing system collects data from one or more sensors. Data may be collected from all the sensors or the data may be only collected from a portion of the sensors, depending on the configuration of the system. For example, when a golf player is not actively swinging the club at a ball, the system may be configured to not collect data from the sensors to save on power consumption within the sensors.

Next, in block 302, the computing system associates the collected data with a particular player. In one embodiment, various sensor data includes identification numbers that are associated with particular players (e.g., a sensor ID or serial number). Thus, each piece of sensor data received by the computing system can be associated with particular players. For example, a player can pass through a sensor scanner upon arrival at a golf course in order to detect each of the various sensors that will be associated with the player during the outing, or the player can simply provide the sensor identification information. The sensor identification information can then be associated with the player in any suitable data structure such that the computing system, e.g., in block 302, can easily determine which player each piece of data is to be associated with. In other embodiments, other techniques may be used, such as artificial intelligence techniques based on the sensor data, to determine which player is associated with particular sensor data. In other embodiments, the data may not be associated with players but may be associated, for example, with a particular golf course, a particular hole on a golf course, a particular game, or a particular tournament. In other embodiments, the data is not associated with any such entity.

Continuing to block 303, the computing system optionally gathers third party data. Such data may be used in performing calculations or assessing predictions based on the sensor data. This third party data may include, for example, weather data or terrain data, course statistics, player statistics, hole statistics, information about tournaments, information about a player's equipment, vital information about one or more players, user provided data or subscriber provided data, and/or any other such data that may be useful to the system. In other embodiments, no third party data is gathered. In various embodiments, this data is gathered prior to receiving the sensor data, after receiving the sensor data, or at any other appropriate time.

In block 304, the computing system optionally gathers historical records. These historical records may include, for example, information about past performances of the player, past performances related to the particular course or a particular hole of the course, past performances about a particular tournament. Historical records may be used for statistical modeling purposes, for performance comparison purposes, or to assist in the accuracy of making predictions. In one embodiment, predictions are compared with historical records in order to assess accuracy of those predictions and to make improvements on those predictions.

Next, in block 305 the computing system applies statistical models and/or predictive models to the data collected, including the sensor data from block 302, the third party data from block 303, and/or the historical records from block 304 or any other subset or combination of that data. The statistical and/or predictive models may be used to calculate information that is of interest to the golf player or to viewers interested in the golf player. These models may include standard linear aggression, logit or probit regression, neural network models, binary tree models, logical or deductive reasoning techniques, fuzzy logic, or other statistical or artificial intelligence modeling techniques that may be known to those of skill in the art. Additionally or alternatively, simple calculations or transformations of data may be used, for example to generate representations of the sensor data that may be easily understood by users. Such models may be predefined by administrators of the computing device that is performing the method or they may be generated based on past data and analysis. The models may include predictive models configured to predict future information, such as the likely destination position of a struck ball, and/or may include statistical models that aggregate, summarize, or otherwise present information such as a player's recent accuracy or power. In one embodiment, the computing system uses data that it receives in order to improve the models that it uses. For example, by comparing the predictions generated at block 305 with actual results, the computing system may incrementally improve its predictive models.

At block 306, the computing system formats data for respective requesting devices. In one embodiment, the computing system maintains information about one or more users who are interested in receiving information about the current game of golf that is being played. The computing system may further maintain information about the type of devices being used by those interested subscribers. The computing system may then format the sensor data and/or the data produced by the statistical and predictive models for viewing on these various devices. In one embodiment, for devices with a larger display, a map of the entire course may be presented. For devices with more limited display capabilities, only a section of the course may be displayed. Furthermore, some devices may have no display and thus the data may be formatted in an appropriate manner such as audio data, an audio stream, or a common data interchange format such as XML or CSV. The devices for which the data is formatted may include, for example, mobile devices such as mobile phones, desktop computers, audio devices such as radios, televisions, portable data assistants (PDAs), portable media players, tablet computers, e-readers, and other such communications devices.

At block 307, the formatted data is delivered to one or more user computing devices 308. In an embodiment, the data is transmitted to the user based on the type of device that the user will be viewing the data on. Such information may be derived based on information from a request submitted by the user. In an embodiment, the users may be able to choose different formats based on user selections which are recorded by the system prior to sending the data to the users.

In an embodiment, the data is transmitted in conjunction with other related data pertaining to the golf game. This may include, for example, live commentary by sports broadcasters, or live video of the game. Thus, users would have the benefit of both observing the actual game being played and receiving predicted data about the game.

In an embodiment, the information is delivered to one or more computing devices 308 at blocks 307 in real time. Thus, the user may receive the information immediately or in very close proximity to the sensor data being transmitted and collected in block 301. Delivery of information regarding a predicated event, such as a predicted landing spot of a ball, may be determined by the computing system and transmitted to one or more user computing devices before the event actually occurs (e.g., before the ball actually lands). Similarly, the computing system may collect sensor data and calculate a predicted trajectory of a golf ball, and then deliver information about the trajectory of that golf ball to users. This allows users to have information on a faster basis than would ordinarily be permitted by traditional observation methods. Many sports viewers enjoy watching sports broadcasts that are near the actual time of the sports event, rather than hours or days after the event has concluded and the results are known, and so real-time data transmission is beneficial to these viewers and to others.

In other embodiments, data may be transmitted on a delayed basis, but still near in time to the actual event, thus making the computing system effectively real time. In various embodiments, a one second, thirty second, one minute, five minute, ten minute, twenty minute, or even one hour delay may be acceptable, depending on circumstances. In other embodiments, the data is stored for later delivery at a specific time or upon user requests. Thus, any data described herein may be generated and transmitted on a delayed basis or on a real-time basis.

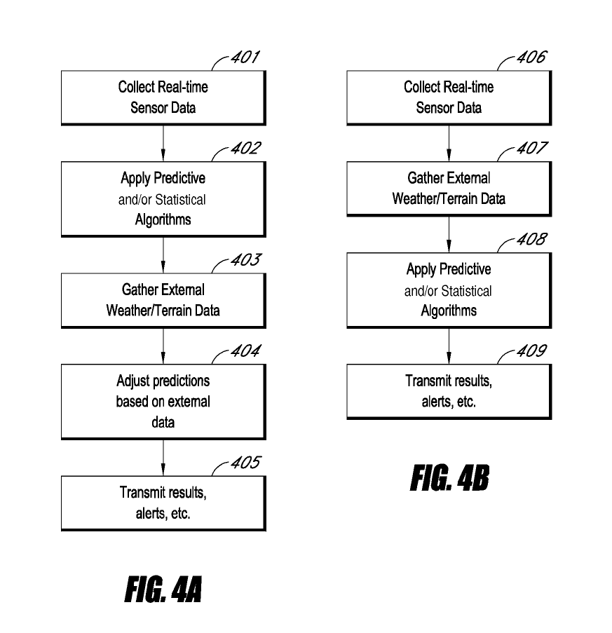

FIGS. 4A and 4B are flowcharts illustrating embodiments of methods providing predicted data regarding a golf game. In FIG. 4A, at block 401, the computing system accesses real time sensor data. At block 402, the computing system applies one or more predictive and/or statistical algorithms to the collected real time sensor data. These predictive and/or statistical algorithms may incorporate other data such as the third party data and the historical records described previously or any other data that may be used by the system. Such information may be sufficient to calculate, for example, the trajectory of a golf ball based upon sensor information regarding the club striking the ball.

At block 403, the computing system accesses external weather and/or terrain data. This data may indicate the weather and topography of the course either at the particular location of the player or within the general vicinity of the player. This information may be obtained from individual sensors installed at or near the location of the player or they may be obtained from services such as weather services or land title or land mapping information services.

At block 404, the computing system adjusts the predictions calculated at block 402 based on the external data accessed at block 403. Thus, for example, the calculated trajectory of a golf ball may be adjusted based on weather information, such as wind speed or current precipitation. The trajectory may also be adjusted based on the altitude of the ground where the ball is predicted to strike or the type of grass or other surface where the ball is expected to land. Such adjustments thus may provide improved accuracy of predictions enabling recipients of those predictions to receive more accurate information in a real time manner. In one embodiment, the computing system improves these adjustments by comparing the predictions with actual trajectories of the ball or other actual data related to the predictions, thereby allowing the predictions to become more and more accurate over time.

At block 405, the computing device initiates transmission of the predictions to one or more users. This may include the golf player, other people on the golf course, or any other users on the Internet (or other computer network) or other computers configured to receive such data. The transmitted data may include alerts based on comparisons of the resulting data or calculations performed on the resulted data. For example, the system may send an alert if the expected distance that the ball will travel exceeds a certain threshold as predefined by the golf player or other user. In an embodiment, these alerts are individually transmitted based on specific user configurations so that each user may provide conditions when alerts are sent or may specify what results are to be transmitted to that user. Other alerts may occur when the ball veers a certain distance to the side, when the ball is expected to land within a predetermined area, and so on.

In an embodiment, a user may be able to select particular types of events in which they are interested, and then the system will only transmit information in which that user is interested. Thus, various users, including the actual golfer and/or one or more viewers, may receive different types of alerts (e.g., based on different user-defined criteria) in various different manners. The user may make such a selection via an online form or user profile, and the selection may be stored in a data structure or other storage device in association with the user's account or other user identifier. Then, when the system determines that an event has occurred, it compares the event with the user selections in the database. For example, the user may indicate interest only in strokes that are predicted to land on the putting green, and the computing system will inform the user accordingly. Alternatively, the computing system may be configured to send, to the user, notifications for all events for a particular player, course, competition, or the like. The alerts may be communicated as a news feed, as video or audio streams, as text messages, and in other such formats described herein or otherwise known.

In one embodiment, the golfer (and/or other user) may have user-defined preferences to receive audio alerts (e.g., different series of tones, sounds, or voices) that are meaningful to the golfer without requiring the golfer to view a display and/or otherwise read information regarding alerts. For example, if a golfer's swing is not aligned properly, a first tone or other sound may be provided to the golfer to indicate such. Audio tones may be provided to the golfer via a dedicated audio device in communication with the computing system, or via an existing device used by the golfer, such as the golfer's mobile device that executes a mobile application configured to interface with the computing system. Accordingly, in one embodiment the feedback provided by the computing system may be used as a trainer of the golfer that provides real-time feedback regarding the golfer's stance, approach, swing, follow through, and the like. Alerts may be provided for improvements in such areas, or changes of a certain amount or percentage in any of these or related areas.

Turning now to FIG. 4B, at block 406, the computing system accesses real-time sensor data. At block 407, the computing system accesses external weather and/or terrain data. At block 408, the computing system applies one or more predictive and statistical algorithms using the sensor data, the external weather and/or terrain data, and any other data that may be collected by the system. At block 409, the computing system initiates transmission of the predictions, such as in the various alert formats discussed above. Thus, in the embodiment shown in FIG. 4B, the weather and/or terrain data is incorporated directly into the predictive and statistical algorithms whereas in FIG. 4A the weather and/or terrain data is used to adjust predictions that are made without that data.

The embodiment of FIG. 4A may be used, for example, to improve the predictions of an existing predictive algorithm that does not incorporate weather or terrain data, or it may be used to demonstrate, via a graphical or other presentation, the effect of current weather conditions or terrain conditions on the calculated information. For example, a user may be able to learn how far and in what direction a golf ball is caused to travel due to high winds. The user may receive such information in real time and thus take future corrective actions on successive strokes. For example, the displayed prediction might indicate that the wind is causing the ball to travel several yards to the east, and so the player can compensate by aiming several yards to the west.

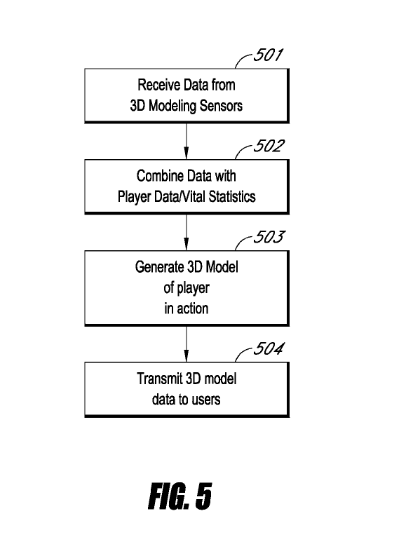

FIG. 5 is a flowchart illustrating one embodiment of a method of broadcasting a three-dimensional model of a player to interested users. In an embodiment, users are able to view and manipulate the 3D model by rotating it or focusing on particular parts of the model, such as the positioning of the player's feet, hands, or body. Thus users may use this, for example, to observe the performance of professional athletes and improve their own technique by carefully studying those professional athletes.

At block 501, a computing system accesses data from one or more three-dimensional modeling sensors. The sensors may be configured in any manner previously described. For example, these sensors may be attached, in one embodiment, to the player and/or to the player's golf club. In other embodiments, the sensors are separate from the player and the player's clubs and record the position of the player based on video and/or image analysis. In one embodiment, one or more sensors are configured to project, onto the golf player, an electromagnetic grid such as on a grid of light in the ultraviolet, visible, or infrared spectrum, thereby allowing the sensors to detect the three-dimensional position of the player, ball, or other entity without the need to place any items on the player, ball, or other entity (which may, for example, hamper the player's performance). The data may thus be sufficient to enable the construction of a three-dimensional model of the player and the player's performance during a golf swing or during other times of the game of golf.

At block 502, the computing system combines the data received from the three-dimensional modeling sensors with data about the player such as, for example, vital statistics about the player. Information such as the height, weight, gender, and/or body shape of the player may be useful in improving the accuracy of the three-dimensional model. Furthermore, such data may allow an accurate model to be constructed without the need for substantial and possibly invasive sensors placed on or near the player. These statistics may be collected by direct user input about the player or by measurement of the player received from one or more sensors employed by the system.

In an embodiment where particular player data is not available, that player data may be interpolated or mathematically modeled based on other data or default player data may be used. In an embodiment, the data may include image or other data about the user, enabling an accurate picture of the user to be constructed. For example, image data of a player's face may be used so that an accurate representation of the player's face may be placed on the resulting three-dimensional model.

At block 503, the computing system generates three-dimensional modeling data of the player in action, wherein the modeling data may be rendered by the a suitable computing device, such as the user computing devices discussed above. Accordingly, the computing system may generate different versions of three-dimensional modeling data that are suited for various computing devices, such as a first set of three-dimensional modeling data that is used to render three-dimensional images on a mobile phone, and a second set of three-dimensional modeling data that is used to render three-dimensional images on a television. The three-dimensional modeling data may include information such as the position of the player, the direction and speed of the player or any part of the player, and the motion of the golf club as the player is swinging it. The three-dimensional modeling data may be of the golf player alone, of any particular portion of the golf player, of the golf player and the golf club, the golf club alone, or any other region. The more detailed models such as models of the club alone or of only a part of a player may be used to help focus viewers on particular aspects of a player's technique, such as what a player does with the wrists during a stroke or where the player positions his or her feet on the ground during the stroke.

Other information may be used to construct the three-dimensional modeling data which may not be immediately visually apparent. For example, the weight distribution of the player may be recorded and graphically presented to users using colors to indicate areas of greater or lesser pressure exerted by the player. This might, for example, give information about which foot is preferable for a player to exert his or her weight on, and how much weight to place on each foot.

In an embodiment, the three-dimensional modeling data is configured to be associated with time so that it may be played back as a video. The three-dimensional modeling data may be rendered as a wire frame, as a generic block model, or as a model specifically configured to appear like the actual player. In an embodiment, the appearance of the player is replaced with the appearance of another person such as the user, thus allowing the user to appear as the golf player in the three-dimensional model.

At block 504, the computing system transmits the three-dimensional modeling data to one or more user computing devices. The modeling data may be transmitted in any number of forms to make the model renderable or otherwise accessible to various users. For example, it may be transmitted in VRML format or it may be rendered as a video and thereby presented to the user in that form. In one embodiment, the user is able to provide information about how the three-dimensional model is to be rendered on the display and the system renders the model according to the user's specifications and transmits the resulting rendered data. For example, the user may wish to observe the golf player from the front, the side, and the back and the computing system could generate three-dimensional modeling data that is renderable to depict those various views of the player. This provides a substantial advantage to users wishing to analyze and understand a player's technique.

In an embodiment, the modeling data is transmitted in real time to users. In another embodiment, the data is stored for later transmission.

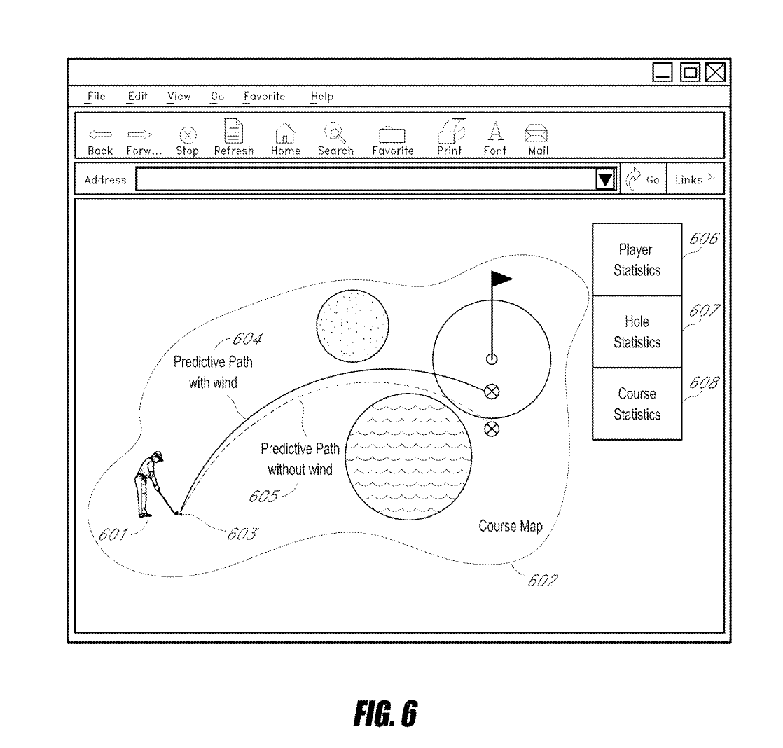

In an embodiment, the computing system constructs user interface data and transmits that data to a user's web browser such that the user's web browser renders the data as a web page in the browser. In various embodiments, the transmitted data may be HTML, VRML, XML, SGML, video data, image data, scalable vector graphics, and the like. FIGS. 6-12 show some user interfaces generated in various embodiments of the invention.

FIG. 6 is a sample user interface that may be generated and presented by the computing system. The sample user interface illustrates a player 601 on a map of the golf course or the particular hole of the golf course 602 based on location data received from one or more sensors associated with the player 601. The player 601 in FIG. 6 is shown having just hit the golf ball 603. In this embodiment, the user interface displays both the predicted path of the golf ball when wind data is incorporated 604 and the predicted path of the golf ball when the wind data is not incorporated 605. Thus, in the embodiment shown in FIG. 6, a user observing the golf player 601 is able to see in real time, such as before the ball has reached its destination, the predicted path of the ball both with and without consideration of the wind. Other weather data may be similarly incorporated into the model and display.

Other such predictions may also be shown on this map. In one embodiment, the position of other players and/or the locations of the balls of other players may be shown on the map 602. Additional information that may be shown on this page or on a separate page includes statistics about the player 606, statistics about the particular hole of the golf course 607, and/or statistics about the overall golf course 608. Such information may be derived from historical records, derived from the sensor data, or both.

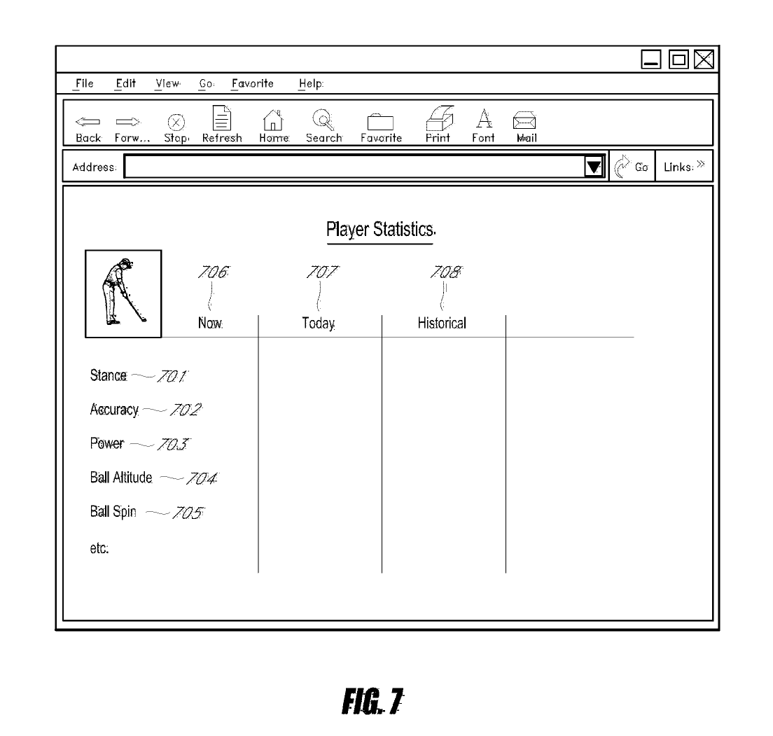

FIG. 7 is a sample user interface that depicts information about a particular player. Again, the user interface presented may be transmitted by any number of means and rendered on a various user computing devices. The user interface displayed comprises a table of various parameters or statistics about a player. These statistics may include measures of stance 701, measures of accuracy 702, measures of swing power or striking power 703, measures of ball altitude 704, measures of ball spin 705, and any other information that may be collected or calculated in the system. In an embodiment, the user retrieving the particular information at the time is able to select the information to be displayed.

In the embodiment of FIG. 7, information is presented about the particular player in real time in column 706, and for various time periods in other columns, such as for the current day 707 and for overall historical periods 708. Other time periods may be selected and added or removed by a user of the system. The real time column 706 may show real time data collected from sensors. The column 706 may be automatically updated as the information changes or at any time that the golf player takes a stroke. Such real-time updates, as used here and in other aspects of embodiments of the invention, may be transmitted by any number of means, including AJAX Javascript, push communications, Comet, long polling, SMS messages, or the like. Thus, a user of the system viewing the tables shown in FIG. 7 is able to compare various statistics or other information about a player in real time with the player's past performance or current performance during the day. Such information may provide the user with a sense for whether the golf player is performing better, worse, or otherwise differently during a particular game. Depending on the embodiment, certain columns of information may be illustrated in the form of differences with respect to historical averages. For example, the power indicator in column 706 may indicate a plus or minus percentage that indicates a relationship of the current stroke's power with respect to the corresponding figure in column 708 (or compared to the daily power average in column 707). In another embodiment, the player statistics may be shown in terms of comparison with a different player, such as a professional golfer. Thus, an amateur golfer may view comparisons between the various aspects of the amateur players game and similar aspects of a professional players game.

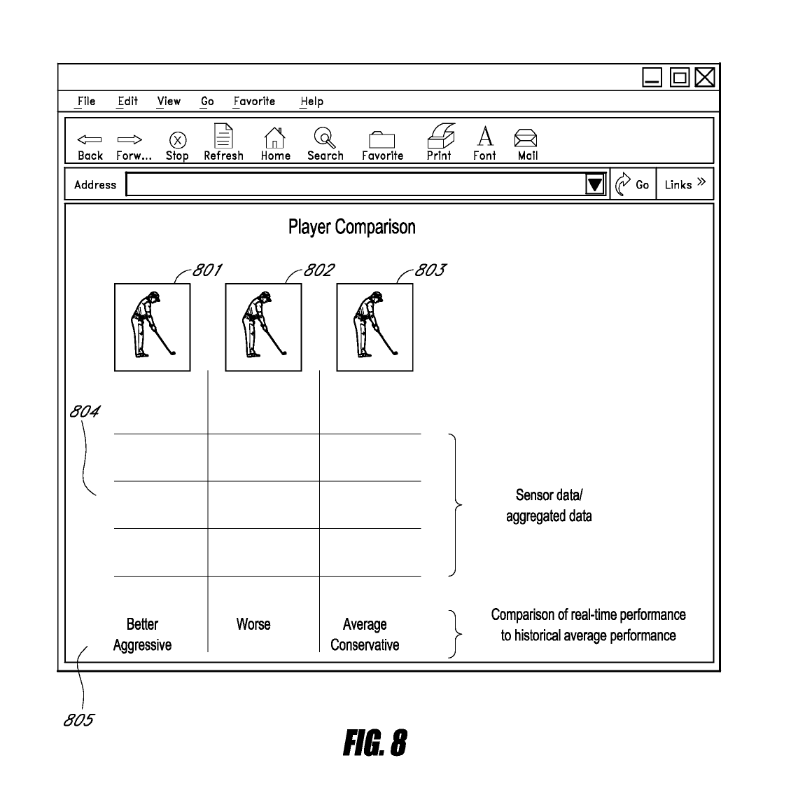

FIG. 8 is a sample user interface this depicts performance information regarding several players. For example, three players 801, 802, and 803 are depicted with relevant data about those players presented in table 804. Part or all of data may be based on sensor data and may include raw sensor data or aggregated or calculated data such as that shown in FIG. 7, or any other data. The data may be updated in real time so that the viewer may have the most up to date calculations or information about the players being compared.

Additionally, an overall summary 805 of each player's performance may be displayed. This summary information may compare the player's real time performance with past performances or other historical data to indicate the degree to which the player is playing differently than normal. The summary information may be one or two descriptive words, as shown, or it may be one or more numerical scores or other more detailed indicators.

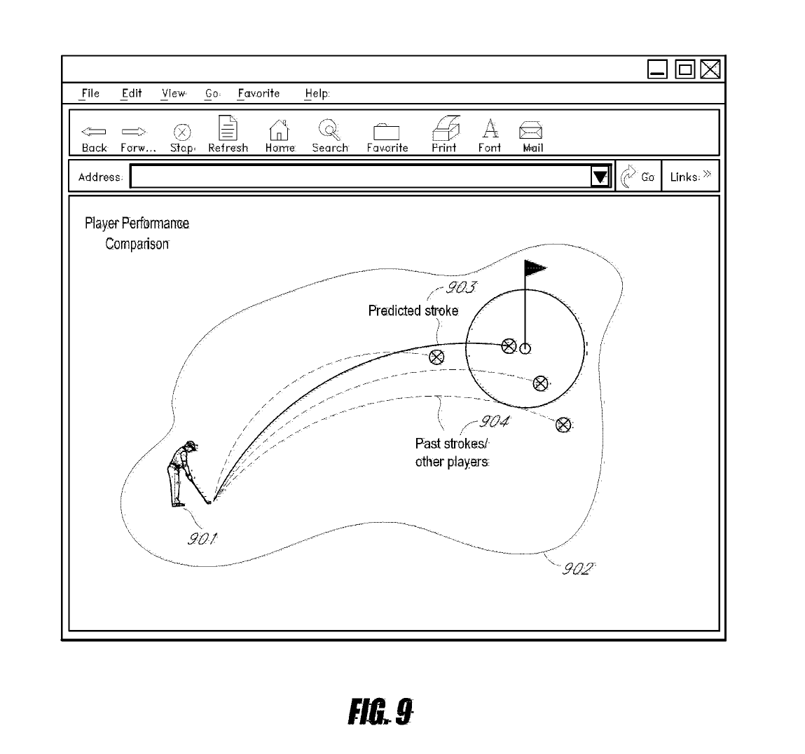

FIG. 9 is a sample user interface that depicts a player performance comparison. In this embodiment, a golf player 901 is shown swinging a golf club on a course 902. When the player strikes a ball, a predicted stroke 903 may be calculated and displayed in real time. Additionally, the trajectories of other strokes taken by the same player or other players 904 are displayed on the course, thereby allowing the player or any other user to compare the current strokes with other strokes taken on the same course, thus giving the user a sense for the player's performance compared to him or herself or compared to other players. In an embodiment, the displays of players' strokes are maintained on the display during the time that the ball corresponding to the display is in flight. In an embodiment, the display also shows the actual position and/or trajectory of the ball while it is in flight.

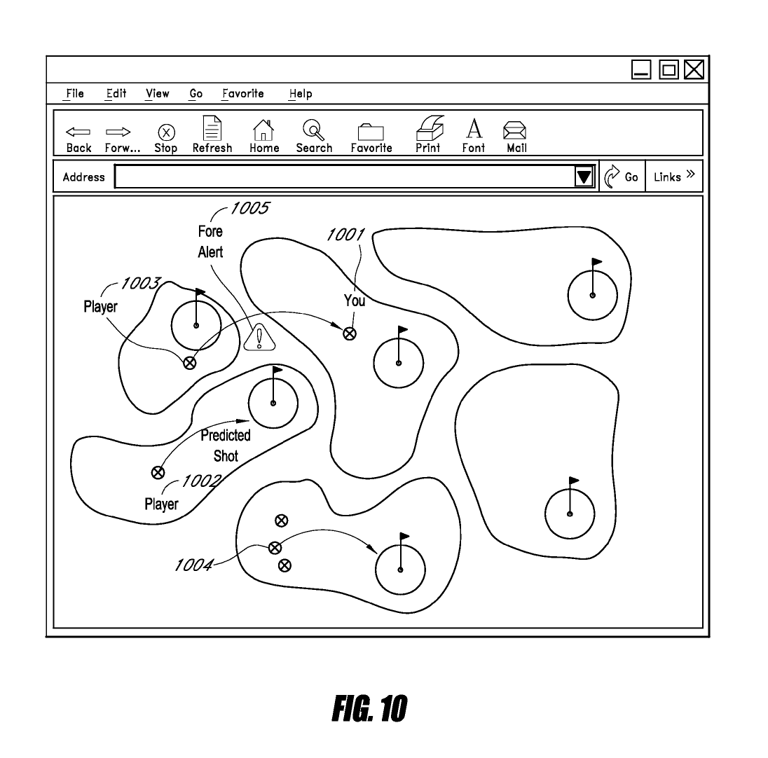

FIG. 10 is a sample user interface that depicts a map of a golf course (or portion of a golf course) and locations of players on the golf course. In one embodiment, the image of the golf course is generated based on terrain data stored and/or accessed by the computing system, or collected via sensors or other data sources. A larger or smaller portion of the course may be shown in various embodiments. The positions of one or more players may be shown on this map. For example, player 1001 is shown as being the current user, and the location of player 1001 may be determined based on GPS or other sensor information received from the user. Other players 1002, 1003, and 1004 may be shown on the golf course with predicted trajectories of strokes taken by those players illustrated also.

In an embodiment, the system calculates in real time the anticipated path or destination of the golf ball and compares it to any one of a number of conditions. For example, if the stroke is calculated to travel within a certain vicinity of a person, a “fore alert” 1005 may be transmitted to that person and/or to any number of other persons, thus alerting the persons of an incoming golf ball prior to the ball arriving at that location. Thus, the alerted persons may be able to take appropriate preventive action and possibly avoid substantial injury. The location of the persons being warned may be ascertained by a GPS system that transmits location data for each of several people on the course. Alternately, heuristics may be used to determine whether to raise a fore alert. For example, the system may assume that it is likely that players will be near the tee-off area for each hole, so it may generate an alert if the ball is predicted to pass through the tee-off area. Fore alerts may be provided to individual persons, such as via a dedicated electronic device in communication with the computing system or a mobile computing device (e.g. a cell phone) configured to communicate with the computing system (e.g., such as via push messaging to the cell phone), in order to provide customized alerts of potential danger to persons on the golf course (or near the golf course). Alternatively, fore alerts may be broadcast among certain areas, such as on loudspeakers at particular sections of a golf course (e.g., near a tee off area for a particular hole where a recently hit ball is headed).

The computing system may also be able to calculate whether a ball is likely to land near a hole on the golf course or likely to land in any other part such as a sand trap or a water trap, and thereby inform the user prior to the ball reaching that destination. In an embodiment, the system determines whether the stroke meets a certain condition and provides the golf player with an appropriate alert in response to that calculation. For example, if it is determined that the player has struck the ball a record distance or record accuracy, then the system may present a congratulatory message such as a clapping sound, thus indicating the result of the stroke to the player.

In other embodiments, the system may calculate an expected number of strokes that will be required for the player to reach the hole and thus provide an indication of this calculation to the user in real time. This may be combined with an indication of how many strokes over or under par the player is likely to take. Such a calculation may be based on the sensor data for a particular stroke, sensor data for other strokes taken on the same hole, historical data about the player, or other historical or related data. Such information about the predicted number of strokes, and other data, may also be broadcast to the users, thus allowing users not present at a golf course to follow the entirety of a golf game of multiple players during a live broadcast.

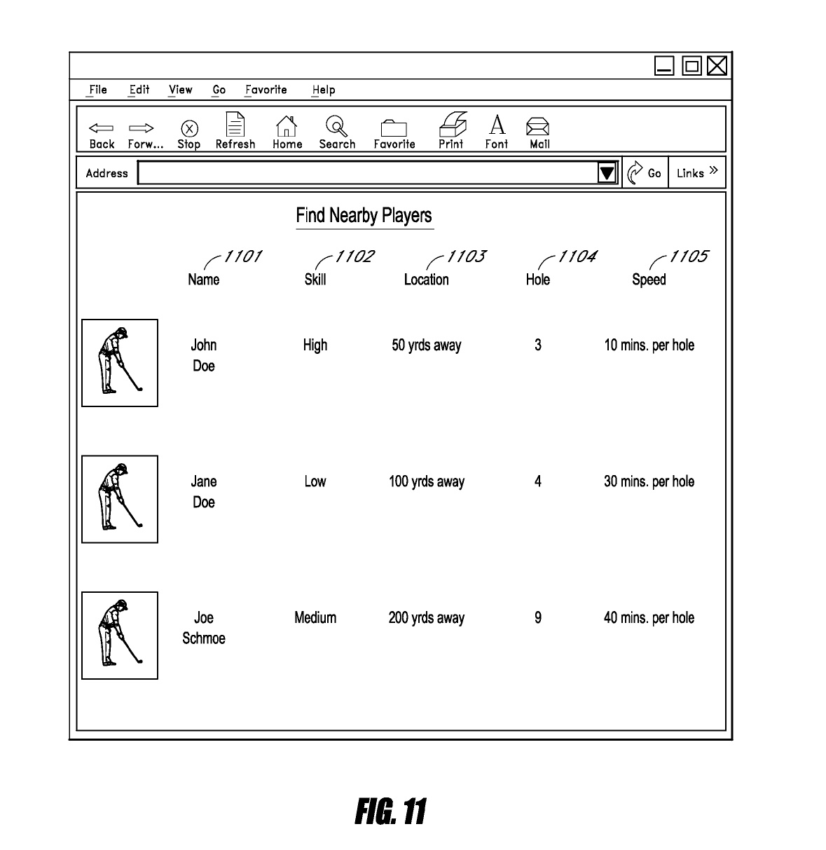

FIG. 11 is a sample user interface that depicts the location and other information of players on a golf course. In this embodiment, the user's location may be determined based on sensor information, GPS, or other such information, and other players are identified based on their proximity to the player and other information. The user interface may present other information about nearby user's skill 1101, physical location 1102, current hole played 1103, and speed of play 1104.

Such information may be useful, for example, in determining whether certain players are playing too quickly or too slowly, and thus enable players to adjust their game as necessary. They may also facilitate players in finding other players on the course so that they may join in their current game. Such a system might enable users to find other players of similar skill or other attributes, thus improving matches among users.

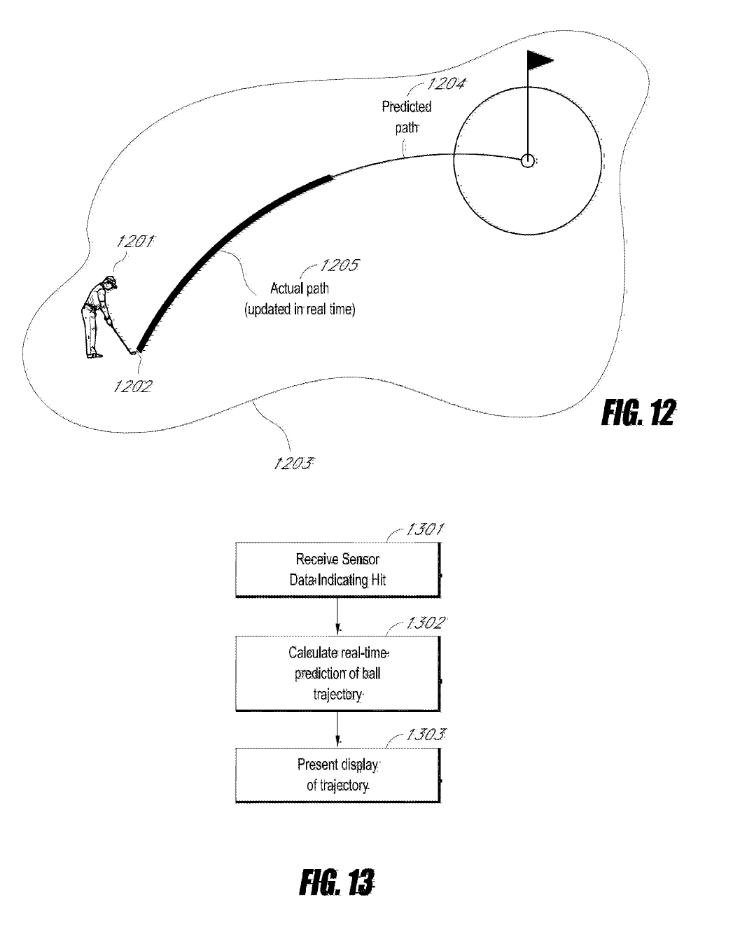

FIG. 12 is a sample user interface that depicts a predicted path of a golf ball and an actual path of the ball. Such a display may be useful to those developing predictive algorithms in order to improve those predictions and they may be useful in real time displays of strokes during a golf game so that a predicted path may be immediately (or very quickly) shown after the ball is hit and the actual speed and location of the ball being hit may be overlaid on that predictive path.

In the example, of FIG. 12, the player 1201 is shown hitting a golf ball 1202 on golf course 1203. The sensor data is used to calculate a predicted path of the golf ball 1204 and the predicted path is shown as soon as it is calculated (possibly well before the ball lands). Then, as the actual path of the ball is determined based on additional sensor data, camera data, or other information, the actual path of the ball 1205 is shown overlaid near or on the predicted path. This may be shown by using partially transparent lines or lines of different thickness or color. The actual path line may thus update in real time as the ball travels, or may be added later as the actual path data becomes available.

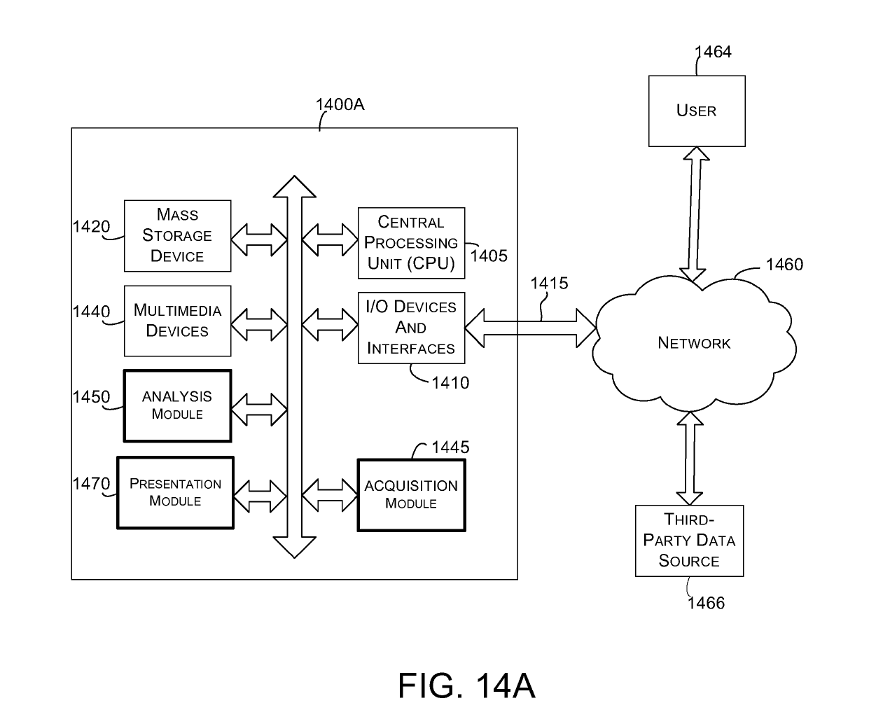

FIG. 13 is a flowchart illustrating one embodiment of a method of displaying an overlay of an actual path and a predicted path as shown in FIG. 12. At block 1301, a computing system accesses sensor data indicating that a ball was hit. At block 1302, the computing system calculates a real time prediction of the ball trajectory using any of the various methods presented in this specification or other known algorithms. Such a real time prediction may be transmitted and displayed to one or more user computing devices, such as the various computing device of FIG. 1.

At block 1303, the computing system updates the user interface to include an actual trajectory of the ball. In one embodiment, this user interface is continuously updated based on timely information about the ball's actual trajectory. In other embodiments, the actual path is provided after the ball has landed. In an embodiment, the predicted path is also simultaneously updated based upon further information about the actual trajectory of the ball, thus allowing the prediction to be calculated and adjusted in real time as the ball travels.

Although the methods and systems described herein have referenced the sport of golf, the systems and methods are applicable to a wide range of uses. Other sports and activities, including baseball, basketball, football, hockey, soccer, sailing, jai alai, track and field, and so on, may employ the techniques described. Additionally, these techniques may be used for industrial or business purposes, such as monitoring shipments of goods, livestock, or documents or valuable items.

### Example System Architecture

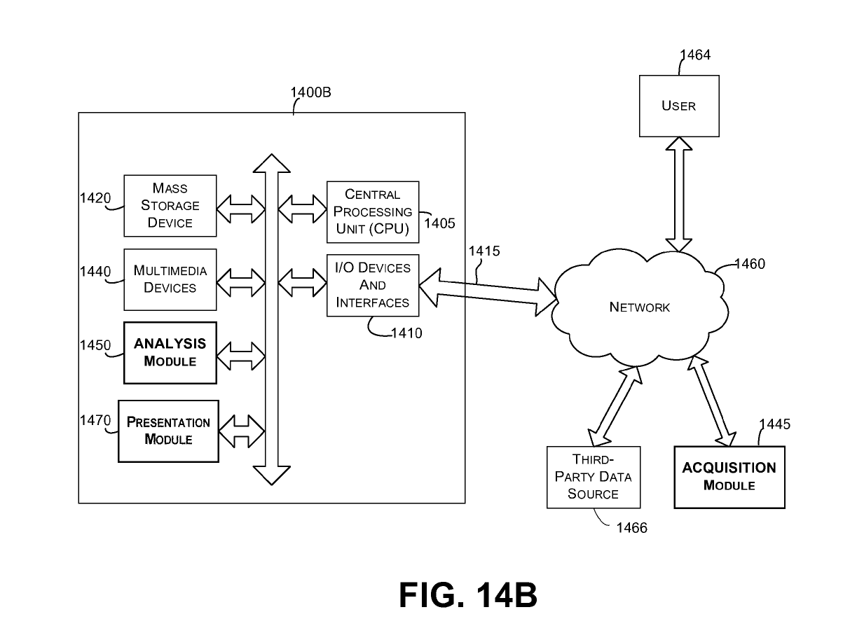

FIG. 14A is a block diagram illustrating one embodiment of a system that manages and/or broadcasts golf data. In the embodiment of FIG. 14A, a computing device 1400A is in communication with a user 1464, as well as a third-party data source 1466, via a network 1460. In the embodiment of FIG. 14A, the computing device 1400A receives data, such as sensor data, regarding one or more golf players, from one or more sensors or other data sources 1466 (other data sources may include, for example, historical databases or weather services) and accesses the data to identify information regarding one or more entities. The computing device 1400 may then perform analysis and prepare information for presentation to the user 1464. The data collection server 102 may include the same or similar components as the computing device 1400A or 1400B (FIG. 14B). Similarly, the computing devices 1400A, 1400B may be used to implement any of the methods discussed herein.

The network 1460 may include any communication network or combination of communication networks, such as one or more of the Internet, LANs, WANs, MANs, etc., for example. In the embodiment of FIG. 14A, the computing device 1400A includes a computing system having one or more computing devices (e.g., computers). The computing device 1400A may include, for example, a single computing device, a computer server, a smart storage unit, or a combination of one or more computing devices and/or computer servers. Depending on the embodiment, the components illustrated in the computing device 1400A may be distributed amongst multiple devices, such as via a local area or other network connection. In other embodiments the computing device 1400A may include fewer and/or additional components that are illustrated in FIG. 14A.

The exemplary computing device 1400A may be a general purpose computer using one or more microprocessors, such as, for example, an Intel® Pentium® processor, an Intel® Pentium® II processor, an Intel® Pentium® Pro processor, an Intel® Pentium® IV processor, an Intel® Pentium® D processor, an Intel® Core™ processor, an xx86 processor, an 8051 processor, a MIPS processor, a Power PC processor, a SPARC processor, an Alpha processor, and so forth. The computer may run a variety of operating systems that perform standard operating system functions such as, for example, opening, reading, writing, and closing a file. It is recognized that other operating systems may be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Microsoft® Windows® XP, Windows® 7, Palm Pilot OS, Apple® MacOS®, Disk Operating System (DOS), UNIX, IRIX, Solaris, SunOS, FreeBSD, Linux®, or IBM® OS/2® operating systems. In other embodiments, the computing device 100A may be controlled by a proprietary operating system. Conventional operating systems control and schedule computer processes for execution, perform memory management, provide file system, networking, I/O services, and provide a user interface, such as a graphical user interface (“GUI”), among other things.

The computing device 1400A includes one or more central processing units (“CPU”) 1405, which may each include one or more conventional or proprietary microprocessor(s). The computing device 100A may further include one or more memories 1430, such as random access memory (“RAM”), for temporary storage of information, read only memory (“ROM”) for permanent storage of information, and/or a mass storage device 1420, such as a hard drive, diskette, or optical media storage device. The memory 1430 may store software code, or instructions, for execution by the processor 1405 in order to cause the computing device to perform certain operations, such as gathering sensor-related data, processing the data with statistical and/or predictive models, formatting data for user devices or other presentation, transmitting data, or other operations described or used herein.

The methods described and claimed herein may be performed by any suitable computing device, such as the computing device 1400A. The methods may be executed on such suitable computing devices in response to execution of software instructions or other executable code read from a non-transitory tangible computer readable medium or computer storage device. A computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

The exemplary computing device 1400A may include one or more input/output (I/O) devices and interfaces 1410, such as a keyboard, trackball, mouse, drawing tablet, joystick, game controller, touchscreen (e.g., capacitive or resistive touchscreen), touchpad, accelerometer, and/or printer, for example. The computing device 1400A may also include one or more multimedia devices 1440, such as a display device (also referred to herein as a display screen), which may also be one of the I/O devices 1410 in the case of a touchscreen, for example. Display devices may include LCD, OLED, or other thin screen display surfaces, a monitor, television, projector, or any other device that visually depicts user interfaces and data to viewers. The computing device 1400A may also include one or more multimedia devices, such as speakers, video cards, graphics accelerators, and microphones, for example.

In the embodiment of FIG. 14A, the I/O devices and interfaces 1410 provides a communication interface to various external devices via the network 1460. For example, the computing device 1400A may be electronically coupled to the network 1460 via a wired, wireless, or combination of wired and wireless, communication link(s). The network 1460 may allow communication with various other computing devices and/or other electronic devices via wired or wireless communication links.

In the embodiment of FIG. 14A, the computing device 1400A also includes an acquisition module 1445, an analysis module 1450, and a presentation module 1470. Each of these modules is discussed in further detail below. In general, the word “module,” as used herein, refers to logic embodied in hardware or firmware, or to a collection of software instructions, possibly having entry and exit points, written in any programming language, such as, for example, Java, Python, Perl, Lua, C, C++, C#, Objective C, etc. A software module may be compiled and linked into an executable program, installed in a dynamic link library, or may be written in an interpreted programming language such as, for example, BASIC, Perl, or Python. Software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing device 1400A, for execution by the computing device. Hardware modules may be comprised of connected logic units, such as gates and flip-flops, and/or may be comprised of programmable units, such as programmable gate arrays or processors. The modules described herein are typically implemented as software modules, but may be implemented in hardware, firmware and/or software. Generally, the modules described herein refer to logical modules that may be combined with other modules or divided into sub-modules despite their physical organization or storage.

### Example Modules

In the embodiment of FIG. 14A, the computing device 1400A includes three modules, namely, an acquisition module 1445, an analysis module 1450, and a presentation module 1470. In this embodiment, each of the modules 1445, 1450, 1470 is shown as part of the computing device 1400A. However, in other embodiments, the modules may be distributed across multiple devices, and may be controlled and/or operated by multiple different entities. For example, in the computing device 1400B of FIG. 14B, the acquisition module 1445 is illustrated as a separate component that is in communication with the computing device 1400B via the network 1460.

The acquisition module 1445 is configured to acquire sensor data and other external data such as third-party data. The acquisition module may comprise software alone, hardware alone, or a combination of software and hardware. The acquisition module may be especially adapted to communicate using a variety of network or communications protocols in order to communicate with the sensors or external data sources. Some of these protocols may include standard network protocols, such as HTTP, FTP, SNMP, or the like. The acquisition module may further include hardware drivers, such as USB, FireWire, Thunderbolt (Light Peak), or serial communications drivers, for example to communicate with devices in direct communication with the acquisition module 1445.

The analysis module 1450 is configured to perform predictive, statistical, mathematical, and/or other analysis based on data received from the acquisition module. The analysis module 1450 may include data and/or executable code to perform the analysis, and such data may be directly provided by a system operator, or it may be compiled based on past data received by the system. The analysis module may be able to thus improve its own models as it receives further data, using artificial intelligence techniques such as neural networks, genetic algorithms, simulated annealing, and so on.

The analysis module 1450 may output any variety of derived information, including aggregate or summary data, comparative data, trend data, ranking data, predicted data on speed, position, and/or acceleration, and other such data. In an embodiment, the particular output of the analysis module is dependent upon user data provided by a user of the system or stored in a user profile.

In an embodiment, at least a portion of the results of the analysis module 1450 is identical to a portion of the data received from the acquisition module. In other words, some of the sensor or third-party data may be used in its raw form, rather than being processed or analyzed by the analysis module 1450.

The presentation module 1470 is configured to transmit, or initiate transmission of, the analysis module's results to requesting entities, such as external user 1464, that have registered interest with the system. In one embodiment, the presentation module 1470 provides the analysis data in an unformatted data structure, such as in an XML, CSV, TXT, or other spreadsheet, text, or web accessible data structure. In other embodiments, the presentation module 1470 provides information in user interfaces, such as user interfaces that are configured for rendering by a web browser for display to users. A variety of different presentations may be provided. In some embodiments, the requesting entities may indicate presentation preferences or configurations (e.g., data formats, types of information, players of interest), and the presentation module 170 may transmit data based on the indicated preferences or configurations. The presentation format may also be determined based on the type of device being used by the user.

In an embodiment, any or all of the acquisition module 1445, the analysis module 1450, or the presentation module 1470 are configured to act in real time. Thus, when data is received by the modules, the modules process that data as soon as practicable or necessary to provide users with timely information. In order to achieve this, specialized hardware may be used to gain efficiency, and executable code may be designed to minimize latency or computation time. In an embodiment, the modules, possibly with other modules of the system, are executed within a real-time operating system, to enhance the responsiveness of the system.

Example System with External Acquisition Module

In the embodiment of FIG. 14B, part or all of the acquisition module 1445 may be controlled and/or operated by an entity that is different than the entity that operates and/or controls the computing device 1400B. For example, the operator of the acquisition module 1445 may charge a fee to the operator of the computing device 1400B for providing third-party data and/or sensor data. In the embodiment of FIG. 14B, the computing device 1400B does not necessarily have (and/or need) access to data such as sensor data, historical data, weather data, terrain data, statistics data, or other such data, since the acquisition module 1445 is operated by a third party. In this manner, the act of acquiring data is separated from the act of performing the analysis. For example, in one embodiment the computing device 1400B, such as a commercial website, may request information from the acquisition module 1445 with a request for the acquisition module 1445 to collect certain historical data and to provide the information to the computing device 1400B. In such an embodiment, the operator of the analysis module need not be concerned with keeping the historical data up-to-date, as the data is pulled from an external source that is operated by a separate entity who can take on that responsibility.

Although this disclosure has been described in terms of certain example embodiments and applications, other embodiments and applications that are apparent to those of ordinary skill in the art, including embodiments and applications that do not provide all of the benefits described herein, are also within the scope of this disclosure.

All publications and patent applications mentioned in this specification are herein incorporated by reference in their entirety to the same extent as if each individual publication or patent application was specifically and individually indicated to be incorporated by reference.

What is claimed is:

1. A method of broadcasting real-time information regarding a game of golf to multiple users across a network, the method being implemented by a computer system comprising one or more processors, the method comprising:
receiving requests from one or more users interested in a golf player currently playing a game of golf;
receiving sensor data from one or more sensors associated with the golf player, the sensor data indicating at least real-time position and/or motion data associated with the golf player;
applying a predictive mathematical model to the received sensor data, to produce real-time performance data indicative of performance of the golf player;
configuring the real-time performance data for presentation on one or more user devices associated with the one or more users; and
transmitting the configured real-time performance data via one or more communication networks to the one or more users.

2. The method of claim 1, further comprising externally retrieving data from one or more data sources, wherein the predictive mathematical model is further applied to the externally retrieved data, and wherein the externally retrieved data includes one or more of weather data and terrain data and the predictive mathematical model is configured to predict a three-dimensional trajectory of a golf ball hit by the golf player, based on the sensor data and one or more of the weather data and the terrain data.

3. The method of claim 1, wherein the predictive mathematical model is configured to generate a three-dimensional representation of the golf player based on at least the sensor data, enabling the one or more users to view and manipulate a three-dimensional representation of the golf player's performance.

4. The method of claim 1, further comprising adjusting the predictive mathematical model based on further sensor data received from the one or more sensors.

5. The method of claim 1, wherein the one or more user devices comprise one or more network devices.

6. The method of claim 1, wherein the one or more user devices comprise one or more mobile computing devices, and wherein transmitting the real-time performance data comprises transmitting user interface data adapted for the one or more mobile computing devices.

7. The method of claim 1, wherein transmitting the configured real-time performance data comprises transmitting the performance data in less than about one minute of receiving the sensor data.

8. A computing system comprising:
a computer readable storage device storing instructions configured for execution by the computing system in order to:
receive sensor data from one or more sensors associated with a golf player;
apply a predictive model to the received sensor data, to produce real-time summary data relating to the golf player;
construct graphical display data based on the real-time summary data relating to the golf player; and
transmit the graphical display data to one or more users who have indicated interest in the golf player.

9. The computing system of claim 8, wherein the storage device further stores instructions configured for execution by the computing system in order to receive data from one or more internal or external data sources, and wherein the predictive model is applied to the received sensor data and to the data from the one or more internal or external data sources.

10. The computing system of claim 8, wherein the graphical display data is constructed based on a type of display device used by at least a portion of the one or more users who have indicated interest in the golf player.

11. The computing system of claim 8, wherein the graphical display data comprises a three-dimensional representation of the golf player.

12. The computing system of claim 8, wherein the graphical display data comprises real-time trajectory data of a ball struck by the golf player.

13. The computing system of claim 8, wherein the sensor data comprises position, velocity, and acceleration data for one or more points on the body of the golf player.

14. The computing system of claim 8, wherein the sensor data is received via a wireless network.

15. A method of generating a real-time prediction of a golf ball trajectory during a game of golf, the method comprising:
receiving sensor data from a plurality of sensors associated with a golf player, the sensor data indicative of a golf swing performed by the golf player;
obtaining weather data and terrain data associated with a current location of the golf player;
calculating an estimated trajectory of a golf ball hit by the golf player, based at least in part on the received sensor data from the plurality of sensors, the obtained weather data and terrain data, wherein the estimated trajectory of the golf ball comprises an estimated destination of the golf ball;
determining whether the estimated destination of the golf ball satisfies a predetermined condition relating to a user; and
transmitting an alert to the user if the estimated destination of the golf ball satisfies the predetermined condition, the alert being transmitted in real time to allow the user to receive the alert before the golf ball has reached a destination.

16. The method of claim 15, wherein the predetermined condition is based on a distance that the golf ball is estimated to travel.

17. The method of claim 15, wherein the predetermined condition is based on a distance between a hole and the estimated destination of the golf ball.

18. The method of claim 15, wherein the predetermined condition is whether the estimated destination of the golf ball is within a certain distance of the user, whereby the user may avoid being hit by the golf ball upon receiving the alert.

19. The method of claim 15, wherein the user is the golf player.

20. The method of claim 15, wherein the user is not the golf player.

21. A non-transitory computer-readable medium comprising instructions that, in response to execution by computer hardware, cause the performance of operations comprising:
receiving sensor data from one or more sensors associated with a sports player, the sensor data indicating at least real-time data associated with the player;
applying a model to the received sensor data, to produce real-time performance data relating to the player;
configuring the real-time performance data for presentation on one or more user devices associated with the one or more users; and
transmitting the configured real-time performance data via one or more communication networks to the one or more users.

22. The non-transitory computer-readable medium of claim 21, wherein the one or more user devices are all the same type of device.

23. The non-transitory computer-readable medium of claim 21, wherein the model is applied to the received sensor data and to externally retrieved data to produce the real-time performance data.

24. The non-transitory computer-readable medium of claim 21, wherein the model is applied to the received sensor data and to stored data to produce the real-time performance data.

25. A non-transitory computer-readable medium comprising instructions that, in response to execution by computer hardware, cause the performance of operations comprising:
receiving sensor data from a plurality of sensors, the sensor data indicative of an action performed by an acting entity;
calculating estimated positioning data, based at least in part on the received sensor data from the plurality of sensors; and
transmitting a real-time alert based at least in part on a determination made based on the estimated positioning data.

26. The non-transitory computer-readable medium of claim 25, wherein the estimated positioning data is an estimated trajectory.

27. The non-transitory computer-readable medium of claim 25, wherein the estimated positioning data is an estimated destination location.

28. The non-transitory computer-readable medium of claim 25, wherein the estimated positioning data is an estimated velocity.

29. The non-transitory computer-readable medium of claim 25, wherein the determination made based on the estimated positioning data comprises determining whether the estimated positioning data satisfies a predefined condition based on data received from a user.
